(19) United States
(12) Patent Application Publication
(10) Pub. No.: US 2004/0109097 A1
(43) Pub. Date: Jun. 10, 2004

(54) Plane display device with touch panel

(75) Inventor: Che-Kuei Mai, Hsinchu (TW)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: Toppoly Optoelectronics Corp.

(21) Appl. No.: 10/315,110

(22) Filed: Dec. 10, 2002

(51) Int. Cl. G02F 1/1335

(52) U.S. Cl. 349/12

(57) ABSTRACT

A plane display device with touch panel uses a light guide plate of front light of LCD as the substrate of touch panel to replace the glass substrate of conventional touch panel.

### BACKGROUND OF THE INVENTION

1. Field of the Invention

The present invention generally relates to a front light of liquid crystal display (LCD) device with touch panel, and more particularly to a front light of liquid crystal display (LCD) device to use the light guide plate as the substrate of touch panel.

2. Description of the Prior Art

The conventional reflective-type liquid crystal display device usually uses a front light as the light source, then the light rays emitted from the light source are guided into LCD by a plurality of slanted portions (V-cuts) of the light guide plate. As shown in FIG. 1, a reflective-type liquid crystal display device includes a matrix thin film transistor (TFT) 102, a passivation layer 104 and a reflector 106 placed sequentially on the lower glass substrate 100, and a retardation film 116 and a polarizing plate 118 placed sequentially on the upper glass substrate 114. A color filer 112 and a transparent electrode layer 110 are provided sequentially below the upper glass substrate 114. A light source 122 is placed at the lateral end of the light guide plate 120, which is put above the polarizing plate 118. The transparent electrode layer 110 of the upper glass substrate 114 and the reflector 106 of the lower glass substrate 100 are sealed face to face and vacuumed, and then a liquid crystal layer 108 is injected into the space between the pair of glass substrates, specially the space between the transparent electrode layer 110 and the reflector 106. The light rays emitted from the light source 122 are guided into liquid crystal display device by the light guide plate 120 and reflected by the reflector 106 to display the figures or pictures on the screen. The above reflective-type liquid crystal display device is referred to the U.S. Pat. No. 6,323,919 and 6,340,999.

We often use the display screen with touch panel in our ordinary life, such as the introductions of the famous scenery. FIG. 2 is a view illustrating an example of such the touch panel 140 directly adhered on the front light of reflective-type liquid crystal display device 130. The Nissha Company has disclosed the front light of LCD with touch panel referred to the patents of WO9963394, JP11344695, and JP2000162594, as illustrated in FIG. 3. However, Not only the weight and the thickness of the whole display module are increased when the touch panel is directly adhered on the panel of liquid crystal display device, but also the transmission capacity of the light rays is decreased. Besides, too many transparent glass substrates will cause the problems that the depth of focus is longer and the weight of display module is heavier.

### SUMMARY OF THE INVENTION

In the light of the state of the art described above, it is an object of the present invention to provide a reflective-type LCD with touch panel which is immune to the problems of the conventional structure of the touch panel adhered directly on the LCD panel described above. A pair of transparent glass substrates of LCD panel are replaced by the transparent plastic substrates, and the upper transparent substrate is used as the light guide plate. Besides, A transparent resin layer with different material is placed above a plurality of slanted portions (V-cuts) of the upper plastic substrate for planarizing the upper plastic substrate, then a transparent conductive layer (ITO) is coated on the transparent resin layer as the bottom structure of touch panel. Finally, using the conventional processes of touch panel to finish the design of lighter and thinner of display module.

It is also an object of this invention to provide a structure of front light of LCD panel with the film-on-glass type touch panel.

It is another object of this invention to provide a structure of front light of LCD panel with the thin-film-on-glass type touch panel.

It is a further object of this invention to provide a structure of front light of LCD panel with touch panel for the lighter and thinner design, wherein the upper transparent plastic substrate of LCD is used as the light guide plate and the substrate of touch panel.

It is still an object of this invention to solve the problems that the depth of focus is too longer and the transmission capacity of the light rays is decreased.

It is still another object of this invention to provide the material of lower substrate of LCD can be plastic or glass and the material of light guide plate is an UV curable resin.

It is still a further object of this invention to reduce the adhered areas of polarizing plate and retardation film to save the cost of above materials. Besides, the display module is thinner than conventional technology because the polarizing plate and the retardation film are adhered at lateral end of upper transparent substrate.

It is still an object of this invention to decrease the energy loss of light rays that pass through the media of whole display module.

In view of the above and other objects which will become apparent as the description proceeds, there is provided according to a general aspect of the present invention a planar display device with touch panel which comprises a reflective-type LCD display device and a touch panel. The reflective-type LCD display device has a transparent substrate and a light source located at the lateral end of the transparent substrate. The touch panel disposed on the reflective-type LCD display device includes a first transparent conductive layer on the transparent substrate; an adhered layer on the first transparent conductive layer; and a second transparent conductive layer on the adhered layer wherein the transparent substrate is used as the substrate of touch panel.

Base on the idea described above, wherein the transparent substrate is used as the light guide plate.

Base on the aforementioned idea, the planar display device with touch panel further comprises a transparent film located between the transparent substrate and the first transparent conductive layer.

Base on the idea described above, wherein the material of the transparent film is a transparent resin.

Base on the aforementioned idea, wherein the transparent film is made for planarizing said transparent substrate.

Base on the idea described above, wherein the refractive indices of the light guide plate and the transparent film are different.

Base on the aforementioned idea, the planar display device with touch panel further comprises a polarizing plate located between the light source and the lateral end of the light guide plate.

Base on the idea described above, the planar display device with touch panel further comprises a retardation film located between the polarizing plate and the lateral end of the light guide plate.

Base on the aforementioned idea, the planar display device with touch panel further comprises a retardation film located between the light source and the lateral end of the light guide plate.

Base on the idea described above, wherein the reflective-type LCD includes a color filter below the light guide plate.

Base on the aforementioned idea, wherein the refractive indices of the light guide plate and the color filter are different.

Base on the idea described above, wherein the material of the light guide plate is plastic.

Base on the aforementioned idea, the planar display device with touch panel further comprises a transparent plate below the light guide plate, wherein the hardness of transparent plate is larger than the hardness of light guide plate.

Base on the idea described above, wherein the material of the light guide plate is an UV curable resin.

Base on the aforementioned idea, wherein the material of the transparent plate is a transparent glass.

Base on the idea described above, wherein the light source includes two lights located at the opposite ends of the transparent substrate respectively.

There is provided according to a general aspect of the present invention a structure of front light of LCD panel device with touch panel which comprises a first substrate; a matrix thin film transistor on the first substrate; a liquid crystal layer on the matrix thin film transistor; a second transparent substrate on the liquid crystal layer; a light source located at the lateral end of the second transparent substrate; a polarizing plate located between the light source and the second transparent substrate; a retardation film located between the polarizing plate and the second transparent substrate; a transparent film on the second transparent substrate; a first transparent conductive layer on the transparent film; an adhered layer on the first transparent conductive layer; and a second transparent conductive layer on the adhered layer.

Base on the idea described above, wherein the first substrate, the matrix thin film transistor, the liquid crystal layer, the second transparent substrate, the light source, the polarizing plate, the retardation film and the transparent film are the components of the front light of LCD panel.

Base on the aforementioned idea, wherein the transparent film, the first transparent conductive layer, the adhered layer and the second transparent conductive layer are components of the touch panel.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 illustrates a structure view of conventional reflective-type LCD;

FIG. 2 illustrates a structure view of the touch panel adhered directly on the LCD panel;

FIG. 3 illustrates another structure view of the touch panel adhered directly on the LCD panel;

FIG. 4 illustrates the first preferred embodiment of the reflective-type LCD with touch panel according to the present invention;

FIG. 5 illustrates a view of components and processes of an ordinary touch panel;

FIG. 6 illustrates the second preferred embodiment of the reflective-type LCD with touch panel according to the present invention; and

FIG. 7 illustrates the third preferred embodiment of the reflective-type LCD with touch panel according to the present invention.

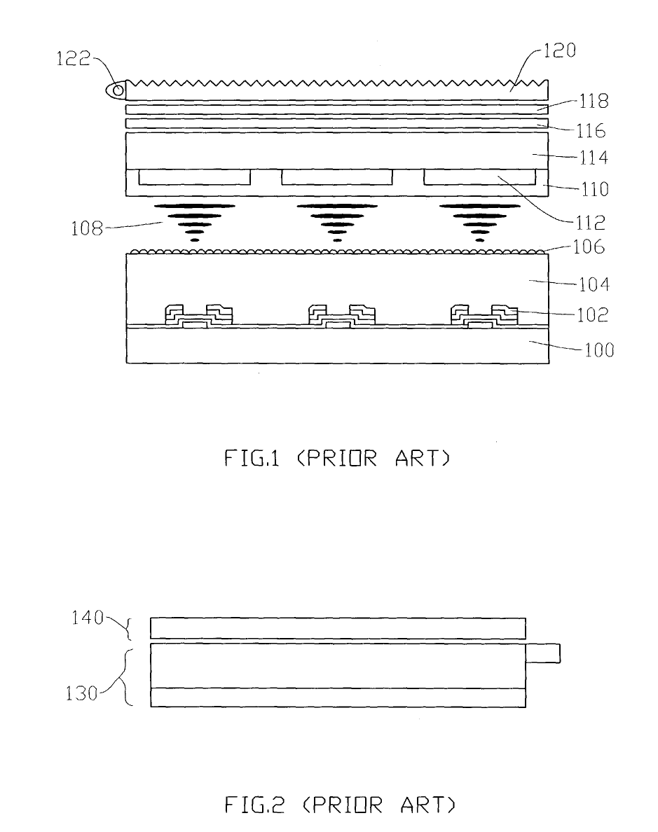

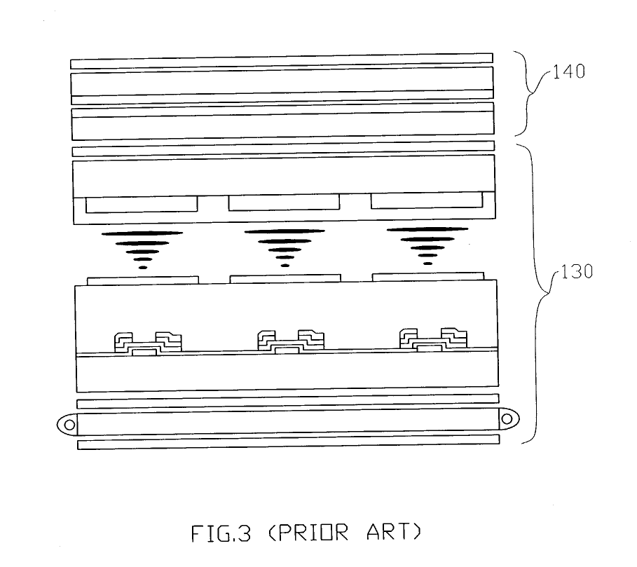

### DESCRIPTION OF THE PREFERRED EMBODIMENT

Some sample embodiments of the present invention will now be described in greater detail. Nevertheless, it should be recognized that the present invention can be practiced in a wide range of other embodiments besides those explicitly described, and the scope of the present invention is expressly not limited except as specified in the accompanying claims.

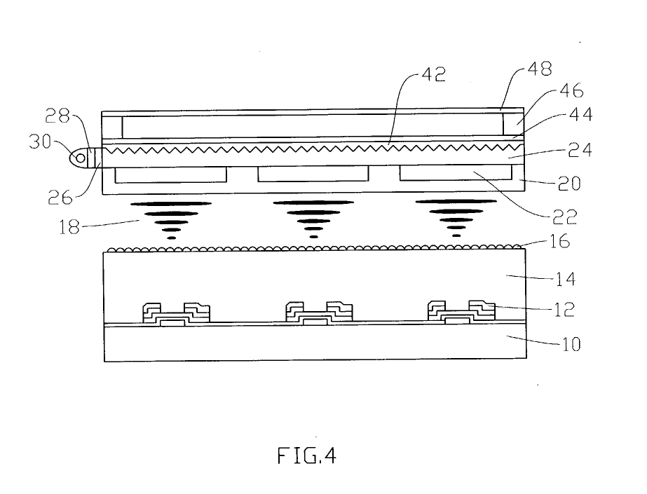

Next, a planar display device with touch panel is disclosed according to this invention. As shown in FIG. 4, there is a transparent substrate 10 as the lower transparent substrate of liquid crystal display whose material can be plastic or glass. The weight of display device is lighter when the material of lower transparent substrate is plastic and the large-scale display device has better rigidity when the material of lower transparent substrate is glass. The array or matrix type thin film transistors (TFTs) 12 are formed on the lower transparent substrate 10 as controlling switches of liquid crystal cells for improving the responding time of LCD. A passivation layer 14 is placed on the TFTs 12 and the lower transparent substrate 10 for protecting the TFTs 12. A reflector 16 used to reflect the light rays emitted from front light is disposed on the passivation layer 14 in this embodiment, but it can be put below the lower transparent substrate 10, too. Then there are sequentially the liquid crystal layer 18, the ITO layer as transparent electrode layer 20, the color filter 22, and the second transparent substrate 24 as the upper transparent substrate of liquid crystal display whose material can be plastic or glass on the reflector 16. Similarly, the weight of display device is lighter when the material of upper transparent substrate is plastic and the large-scale display device has better rigidity when the material of upper transparent substrate is glass. The upper transparent substrate 24 can be used as light guide plate, which is not limited to the wedge plate, flat plate, hollow plate, or other type of plates. Besides, the refractive indices of the second transparent substrate 24 and the color filter 22 are different.

There is a light source 30 located at the lateral end of the upper transparent substrate 24. A retardation film 26 and a polarizing plate 28 are disposed between the light source 30 and the upper transparent substrate 24. The light source 30 can be LED, cold cathode fluorescent lamp (CCFL) or other similar light sources. This second transparent substrate 24 can use convex/concave dots, a plurality of slanted portions (V-cuts) or other light guide components to guide light rays emitted from the light source 30 located at the lateral end of the second transparent substrate 24 toward LCD. The retardation film 26 is the retardation film of quarter wavelength. The above configuration can reduce the adhered areas of the retardation film 26 and the polarizing plate 28 and decrease the thickness of whole display module.

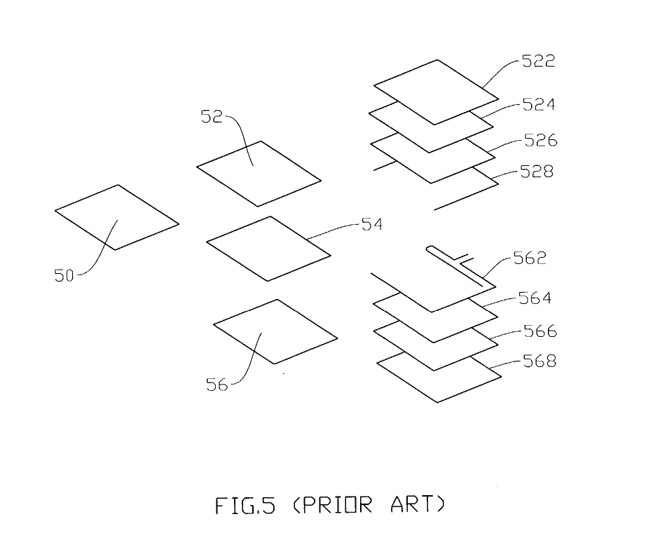

Because the second transparent substrate 24 is used as the substrate of conventional touch panel according to this invention, a transparent conductive layer 44 is coated on the second transparent substrate 24 as the lower electrode plate of touch panel. An adhered layer 46 and an upper electrode plate 48 are sequentially formed on the transparent conductive layer 44 to finish a film-on-glass type touch panel. Please refer to FIG. 5, which describes the components and processes of ordinary touch panel, wherein the lower substrate is replaced by the second transparent substrate 24 of LCD.

A transparent film 42 is coated on the second transparent substrate 24 used as the light guide plate for planarizing the surface of the second transparent substrate 24. The material of transparent film can be a transparent resin and the refractive indices of the transparent film 42 and the second transparent substrate 24 are different.

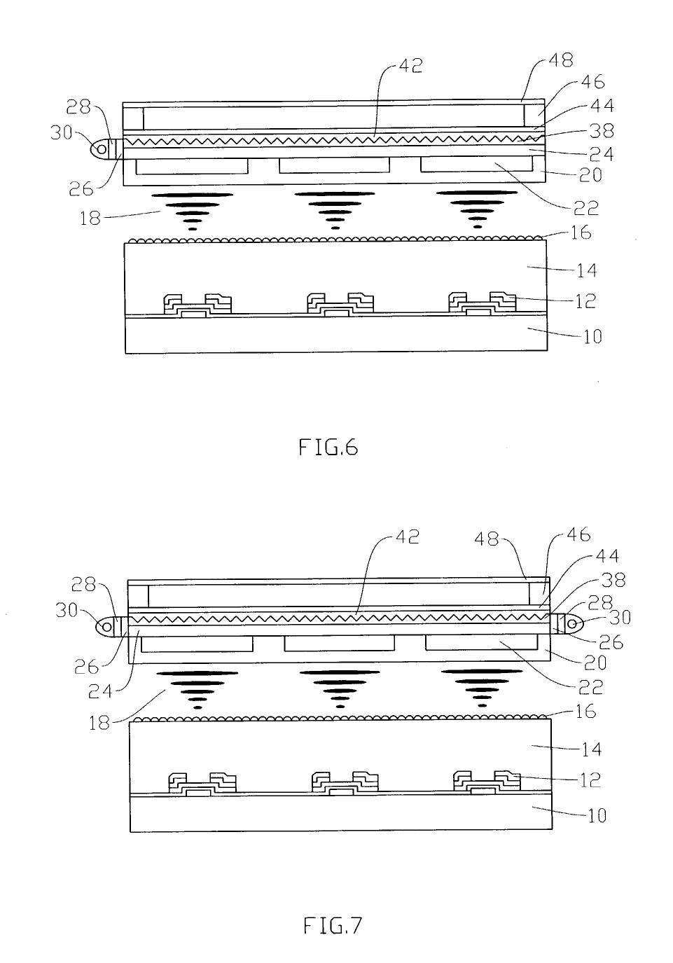

The second transparent substrate 24 used as the upper transparent substrate of LCD panel should be not as the light guide plate. As shown in FIG. 6, it is the second preferred embodiment according to this invention that the material of second transparent substrate 24 is glass, then the convex/concave dots, a plurality of slanted portions (V-cuts) or other light guide components are formed on the second transparent substrate 24. The material of these light guide components can be an UV curable resin. The above configuration is better to put on large-scale display devices.

Besides, the light source of this invention is not limited to a single light. Please refer to FIG. 7, there are two lights 30,32 located at the opposite ends of the second transparent substrate 24 to increase the brightness of whole display module.

It is very good idea to use the upper transparent substrate of LCD as the transparent substrate of lower electrode plate of touch panel according to this invention. Because most of the weight of conventional display module of LCD with touch panel is the weight of the glass substrates and the thickness is thicker due to touch panel adhere directly on front light module. The design of display module according to this invention is lighter and thinner and can solve the problem that the depth of focus is too longer. Besides, the polarizing plate and the retardation film are directly adhered at lateral end of upper plastic substrate so that the above materials are substantially reduced and the thickness of whole display module is thinner. Finally, the transmission capacity of the light rays is increased and the brightness of display device is improved because many transparent substrates are removed.

Although specific embodiments have been illustrated and described, it will be obvious to those skilled in the art that various modifications may be made without departing from what is intended to be limited solely by the appended claims.

What is claimed is:

1. A planar display device with touch panel, comprising:
a reflective-type LCD display device having:
a transparent substrate; and
a light source located at the lateral end of said transparent substrate; and
a touch panel on said reflective-type LCD display device including:
a first transparent conductive layer on said transparent substrate;
an adhered layer on said first transparent conductive layer; and
a second transparent conductive layer on said adhered layer wherein said transparent substrate is used as the substrate of said touch panel.

2. The planar display device with touch panel according to claim 1, wherein said transparent substrate is used as the light guide plate.

3. The planar display device with touch panel according to claim 2 further comprising a transparent film located between said transparent substrate and said first transparent conductive layer.

4. The planar display device with touch panel according to claim 3, wherein the material of said transparent film is a transparent resin.

5. The planar display device with touch panel according to claim 3, wherein said transparent film is made for planarizing said transparent substrate.

6. The planar display device with touch panel according to claim 3, wherein the refractive indices of said light guide plate and said transparent film are different.

7. The planar display device with touch panel according to claim 2 further comprising a polarizing plate located between said light source and the lateral end of said light guide plate.

8. The planar display device with touch panel according to claim 7 further comprising a retardation film located between said polarizing plate and the lateral end of said light guide plate.

9. The planar display device with touch panel according to claim 2 further comprising a retardation film located between said light source and the lateral end of said light guide plate.

10. The planar display device with touch panel according to claim 2, wherein said reflective-type LCD includes a color filter below said light guide plate.

11. The planar display device with touch panel according to claim 10, wherein the refractive indices of said light guide plate and said color filter are different.

12. The planar display device with touch panel according to claim 2, wherein the material of said light guide plate is plastic.

13. The planar display device with touch panel according to claim 2 further comprising a transparent plate below said light guide plate, wherein the hardness of said transparent plate is larger than the hardness of said light guide plate.

14. The planar display device with touch panel according to claim 13, wherein the material of said light guide plate is an UV curable resin.

15. The planar display device with touch panel according to claim 13, wherein the material of said transparent plate is a transparent glass.

16. The planar display device with touch panel according to claim 1, wherein said light source includes two lights located at the opposite ends of said transparent substrate respectively.

17. A structure of front light of LCD panel device with touch panel, comprising:
a first substrate;
a matrix thin film transistor on said first substrate;
a liquid crystal layer on said matrix thin film transistor;
a second transparent substrate on said liquid crystal layer;
a light source located at the lateral end of said second transparent substrate;
a polarizing plate located between said light source and said second transparent substrate;
a retardation film located between said polarizing plate and said second transparent substrate;
a transparent film on said second transparent substrate;
a first transparent conductive layer on said transparent film;
an adhered layer on said first transparent conductive layer; and
a second transparent conductive layer on said adhered layer.

18. The structure of front light of LCD panel device with touch panel according to claim 17, wherein said first substrate, said matrix thin film transistor, said liquid crystal layer, said second transparent substrate, said light source, said polarizing plate, said retardation film and said transparent film are the components of said front light of LCD panel.

19. The structure of front light of LCD panel device with touch panel according to claim 18, wherein said transparent film, said first transparent conductive layer, said adhered layer and said second transparent conductive layer are the components said touch panel.
